(19) United States
(12) Patent Application Publication
(10) Pub. No.: US 2018/0178499 A1
(43) Pub. Date: Jun. 28, 2018

(54) Bonding Apparatus

(71) Applicant: SCREEN Laminatech Co., Ltd., Nara (JP)

(72) Inventor: Mitsuo UEMURA, Nara (JP)

(21) Appl. No.: 15/897,229

(22) Filed: Feb. 15, 2018

Related U.S. Application Data
(62) Division of application No. 14/955,087, filed on Dec. 1, 2015.

(30) Foreign Application Priority Data
Mar. 24, 2015 (JP) 2015-060920

(51) Int. Cl. B32B 37/00; B32B 37/10; B32B 37/18; B32B 38/18; B32B 41/00; G06F 3/041

(52) U.S. Cl. CPC B32B 37/0053; B32B 37/025; B32B 37/1045; B32B 37/18; B32B 38/1858; B32B 41/00; B32B 2307/412; B32B 37/003; B32B 2309/16; B32B 2315/08; B32B 2457/208; G06F 2203/04102; G06F 2203/04103; G06F 3/041

(57) ABSTRACT

A bonding apparatus for bonding a flexible member to a curved member in the atmosphere while preventing air bubbles from entering between the members includes a bonding stage for holding a first member with an inside surface facing up, a flexible carrier sheet for holding a second member with a bonding surface facing the inside surface of the first member, and a moveable bonding roller disposed above the carrier sheet. A control portion causes the bonding roller to move down so that the carrier sheet is depressed into a V-like shape, whereby a portion of the second member is bonded to the first member preceding the remaining portion of the second member, and thereafter, the bonding roller is caused to move along the curved shape of the first member to bond the remaining portion of the second member to the first member.

### TECHNICAL FIELD

The present invention relates to a bonding apparatus for use in bonding a flexible second member such as an organic EL panel to a curved first member such as a cover glass.

### BACKGROUND ART

In general, when bonding a member such as an organic EL panel, a liquid crystal panel, or a touch panel to another member such as a cover glass, it is extremely important to preclude any air bubbles from entering between the two members. Such an entrance of air bubbles might lead to display quality reduction and also cause the members to separate from each other.

A known bonding apparatus capable of bonding while preventing an entrance of air bubbles is of a type that performs the bonding in a vacuum. In such a bonding apparatus, before performing the bonding, two members are put in a vacuum chamber, and then the chamber is vacuumized. After completion of the bonding, the chamber is devacuumized, and the two members having been bonded are removed. However, this bonding apparatus requires a large-scale vacuum chamber and performs vacuumization upon each bonding, resulting in a low-productivity problem.

To overcome this problem, the Applicant proposed a bonding apparatus 50 shown in FIG. 9 (see Patent Document 1). The bonding apparatus 50 is an apparatus in which a roller 54 travels in the direction of an arrow whereby a second plate-like member 400 (i.e., a cover glass) is bonded to an adhesive layer 301 of a first plate-like member 300 (i.e., a touch panel or a liquid crystal panel) mounted on a stage 51, and the bonding apparatus 50 controls the height of pillows 52 and 53, which respectively support a bonding-start side 400a and a bonding-end side 400b of the second plate-like member 400, during the bonding, such that the bonding-end side 400b is kept at a higher position than the bonding start side 400a, thereby preventing a portion of the second plate-like member 400 that has not yet been pressed by the roller 54 from prematurely adhering to the adhesive layer 301 of the first plate-like member 300.

### PRIOR ART DOCUMENT

### Patent Document

Patent Document 1: Japanese Patent No. 4712886

### DISCLOSURE OF THE INVENTION

### Problems to be Solved by the Invention

However, the bonding apparatus 50 is premised on the second plate-like member 400 being straight and flat, and it is by no means assumed that a flexible member is bonded to a curved member.

The present invention has been achieved under the above circumstances, with a problem thereof being to provide a bonding apparatus capable of bonding a flexible member to a curved member in the atmosphere while preventing air bubbles from entering between the members.

### Solution to the Problems

To solve the above problem, the present invention provides a bonding apparatus for bonding a bonding surface of a flexible second member to an inside surface of a first member being at least partially curved inward, the apparatus including a first holding portion for holding the first member with the inside surface facing up, a flexible second holding portion for holding the second member with the bonding surface facing the inside surface of the first member, a moveable pressing portion disposed above the second holding portion, and a control portion for controlling at least the movement of the pressing portion, wherein the control portion causes the pressing portion to move down so that the second holding portion is directly pressed by the pressing portion and depressed into a V-like shape, whereby a portion of the second member that has been pressed indirectly from above the second holding portion by the pressing portion is bonded to the first member preceding the remaining portion of the second member, and thereafter, the pressing portion is caused to move along the curved shape of the first member to bond the remaining portion of the second member to the first member.

It is preferable that the bonding apparatus further includes a first support for supporting a first end of the second holding portion, and a second support for supporting a second end of the second holding portion, and the first end and the second end are situated outside an area where the second member is held, and are spaced apart in a direction in which the pressing portion moves along the curved shape of the first member.

Further, in the bonding apparatus, (1) at least one of the first support and the second support is preferably movable up and down under control of the control portion, (2) at least one of the first support and the second support preferably includes a tension adjusting mechanism for setting a tension of the second holding portion at a predetermined target value, and (3) height control for the pressing portion is preferably complex control including position control in combination with pressure control for causing a reaction force from the second holding portion not to exceed a predetermined threshold.

The pressing portion of the bonding apparatus is, for example, a bonding roller having a radius smaller than the radius of curvature of the first member. The second holding portion of the bonding apparatus is, for example, a sheet- or film-like member with a suction or adhesion layer formed at least in the area where the second member is held. Moreover, the first member of the bonding apparatus is, for example, a cover glass, and the second member is, for example, a flexible organic EL panel, a touch panel, or a flexible organic EL panel with a touch panel.

### Effect of the Invention

The present invention makes it possible to provide a bonding apparatus capable of bonding a flexible member (second member) to a curved member (first member) in the atmosphere while preventing air bubbles from entering between the members.

### BRIEF DESCRIPTION OF THE DRAWINGS

FIG. 1 is a side view of a bonding apparatus according to a first embodiment of the present invention.

FIG. 2 is a control block diagram of the bonding apparatus according to the first embodiment of the present invention.

FIGS. 3(A), 3(B) and 3(C) provide views illustrating a bonding operation by the bonding apparatus according to the first embodiment of the present invention.

FIG. 4 is a side view of a bonding apparatus according to a second embodiment of the present invention.

FIG. 5 is a control block diagram of the bonding apparatus according to the second embodiment of the present invention.

FIGS. 6(A), 6(B), 6(C) and 6(D) provide views illustrating a bonding operation by the bonding apparatus according to the second embodiment of the present invention.

FIG. 7 is a side view of a bonding apparatus according to a variant of the present invention.

FIG. 8 is a control block diagram of the bonding apparatus according to the variant of the present invention.

FIG. 9 is a side view of a conventional bonding apparatus.

### MODES FOR CARRYING OUT THE INVENTION

Hereinafter, embodiments of a bonding apparatus according to the present invention will be described with reference to the accompanying drawings.

### First Embodiment

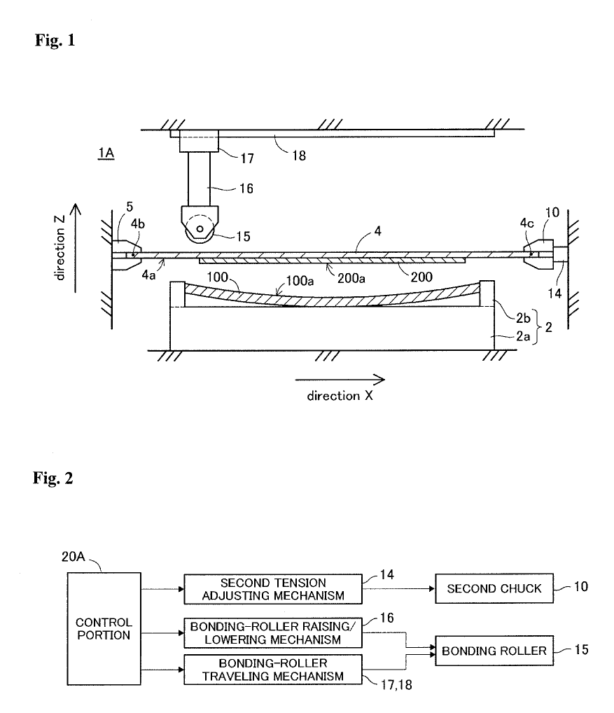

FIG. 1 illustrates a bonding apparatus 1A according to a first embodiment of the present invention. The bonding apparatus 1A is an apparatus for bonding a second member 200 to a first member 100 in the atmosphere. In the present embodiment, the first member 100 is a cover glass having a thickness of from 0.3 mm to 1.1 mm, and the second member 200 is a flexible organic EL panel having a thickness of from 10 μm to 1000 μm. The first member 100 and the second member 200 are not limited to those described above. However, the present invention requires the second member 200 to be flexible and the first member 100 to be essentially inflexible.

As shown in the figure, in the present embodiment, the entire first member 100 uniformly curves inward. Moreover, the second member 200 has a bonding surface 200a with an unillustrated adhesive or adhesion layer formed across its entirety. The second member 200 is bonded to a curved inside surface 100a of the first member 100 by the adhesive or adhesion layer of the bonding surface 200a.

The bonding apparatus 1A includes a bonding stage 2 fixed to its base. The bonding stage 2 includes a main body 2a having a horizontal mounting surface, and a plurality of alignment protrusions 2b sticking out from the mounting surface of the main body 2a. By the main body 2a and the alignment protrusions 2b, the first member 100 is held with the inside surface 100a facing up.

The bonding apparatus 1A includes a flexible carrier sheet 4. The carrier sheet 4 has a first end 4b supported by a first chuck 5 to be described later, a second end 4c supported by a second chuck 10, and a holding surface 4a with an acrylic low-adhesion layer formed thereon. The carrier sheet 4 holds the second member 200 on the holding surface 4a. The second member 200 is held with the bonding surface 200a facing down. That is, the second member 200 is held with the bonding surface 200a facing the inside surface 100a of the first member 100.

The bonding stage 2 corresponds to a “first holding portion” of the present invention. Moreover, the carrier sheet 4 corresponds to a “second holding portion” of the present invention.

The bonding apparatus 1A further includes the first chuck 5 supporting the first end 4b of the carrier sheet 4, the second chuck 10 supporting the second end 4c of the carrier sheet 4, and a bonding roller 15.

The first chuck 5 corresponds to a “first support” of the present invention. The first chuck 5 supports the first end 4b of the carrier sheet 4 by pinching the first end 4b from above and below, as shown in FIG. 1. In the present embodiment, the first chuck 5 is fixed to the base.

The second chuck 10 corresponds to a “second support” of the present invention. The second chuck 10 supports the second end 4c of the carrier sheet 4 at the same height as the first end 4b by pinching the second end 4c from above and below, as shown in FIG. 1. The second chuck 10 is fixed to the base via a second cylinder 14, which expands and contracts in direction X. The second cylinder 14 corresponds to a “second tension adjusting mechanism” of the present invention.

In the case where the tension of the carrier sheet 4 falls below a predetermined target value, the second cylinder 14 contracts under control of a control portion 20A, so that the second chuck 10 moves forward in direction X away from the first chuck 5. On the other hand, in the case where the tension of the carrier sheet 4 exceeds the predetermined target value, the second cylinder 14 expands under control of the control portion 20A, so that the second chuck 10 moves backward in direction X closer to the first chuck 5. This feedback control is performed repeatedly during bonding, so that the tension of the carrier sheet 4 is always maintained at the target value. Note that the target value may be a target range having an upper limit and a lower limit.

The bonding roller 15 has a radius smaller than the radius of curvature of the first member 100. The bonding roller 15 is rotatably attached to a lower end of a cylinder 16, which expands and contracts in direction Z, above the carrier sheet 4. Moreover, the cylinder 16 is fixed at its upper end to a slider 17, which is slidably attached to a guide 18 extending in direction X. The guide 18 is fixed to the base.

The bonding roller 15 corresponds to a “pressing portion” of the present invention. The cylinder 16 corresponds to a “bonding-roller raising/lowering mechanism” of the present invention. Moreover, the slider 17 and the guide 18 correspond to a “bonding-roller traveling mechanism” of the present invention for causing the bonding roller 15 to travel both forward and backward in direction X.

When the cylinder 16 expands or contracts under control of the control portion 20A, the bonding roller 15 correspondingly moves forward or backward (up or down) in direction Z. In the case where the bonding roller 15 moves down and thereby presses the top surface of the carrier sheet 4, the carrier sheet 4 starts to be depressed into a V-like shape. Thereafter, as the bonding roller 15 further moves down, so that the carrier sheet 4 is further depressed, a portion of the second member 200 being held on the holding surface 4a of the carrier sheet 4 is bonded to the first member 100 preceding the remaining portion of the second member 200. At this time, the bonding surface 200a of the second member 200 is brought into line contact, rather than surface contact, with the first member 100.

The cylinder 16 has an unillustrated reaction force detection sensor for detecting a reaction force from the carrier sheet 4. The control portion 20A refers to a reaction force detected by the reaction force detection sensor and controls the raising or lowering of the bonding roller 15 in order not to cause the pressing force on the carrier sheet 4 to exceed a predetermined threshold. That is, in the present embodiment, height control for the bonding roller 15 is complex control including position control in combination with pressure control. By additionally using pressure control, it is rendered possible to prevent the second member 200 and/or the first member 100 from being damaged due to the pressing force becoming excessive.

When the slider 17 under control of the control portion 20A slides forward or backward in direction X along the guide 18, the bonding roller 15 travels in the same direction. The bonding roller 15 travels with a portion of the second member 200 being bonded to the first member 100, so that the remaining portion of the second member 200 is consequently bonded to the first member 100.

FIG. 2 provides a control block diagram of the bonding apparatus 1A according to the present embodiment. As shown in the figure, the control portion 20A performs (1) control related to adjustments of the tension of the carrier sheet 4, and (2) control related to the raising and lowering and the travelling of the bonding roller 15. The raising/lowering control (i.e., the height control) for the bonding roller 15 includes position control and pressure control, as described above.

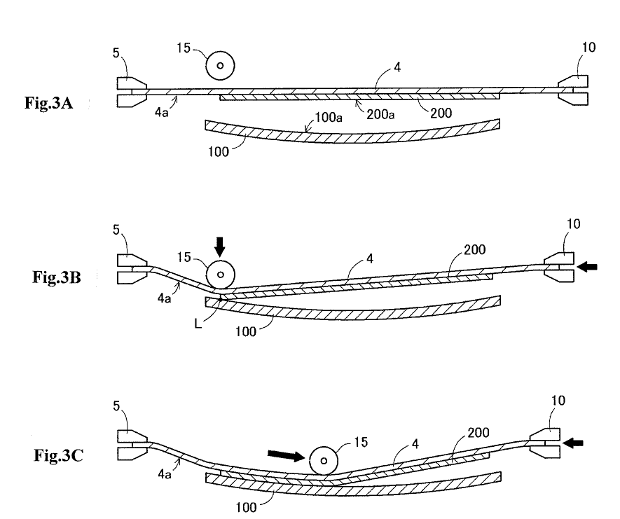

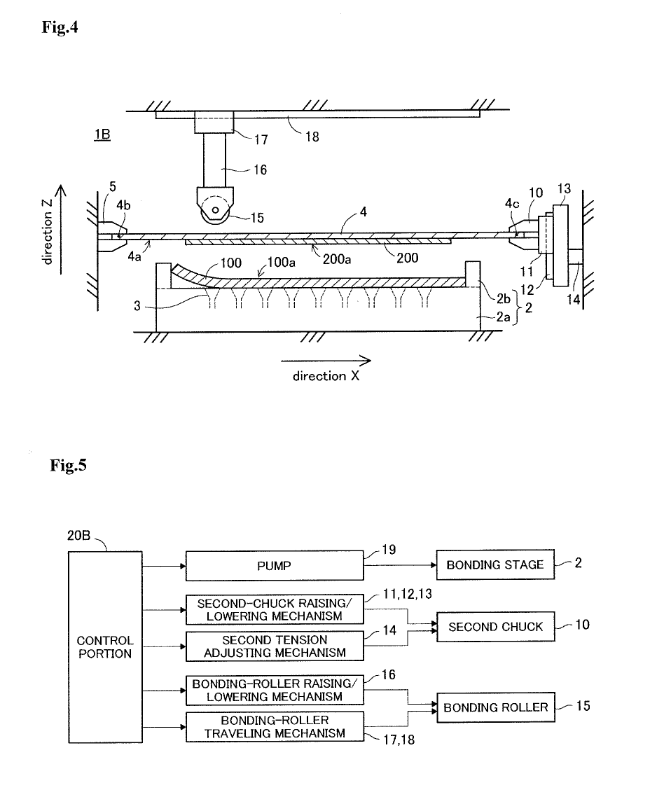

Next, the bonding operation by the bonding apparatus 1A according to the first embodiment will be described step by step with reference to FIG. 3. It should be noted that some components are omitted in FIG. 3.

FIG. 3(A) illustrates an initial state prior to the start of the bonding operation. As shown in the figure, in the initial state, the second member 200 is held on the holding surface 4a of the carrier sheet 4, which is kept horizontally by the first chuck 5 and the second chuck 10, and the bonding surface 200a of the second member 200 faces the inside surface 100a of the first member 100. Moreover, the bonding roller 15 is on standby directly above the end of the second member 200 on the first chuck 5 side.

FIG. 3(B) illustrates a state subsequent to the initial state shown in FIG. 3(A) after the bonding roller 15 has moved down (i.e., moved backward in direction Z) and the second chuck 10 has moved backward in direction X in order to maintain the tension of the carrier sheet 4 at a target value. As the bonding roller 15 moves down, the carrier sheet 4 is directly pressed by the bonding roller 15 and therefore depressed into a V-like shape, so that the end of the second member 200 on the first chuck 5 side, which has been pressed indirectly from above the carrier sheet 4, is bonded to the first member 100 preceding the remaining portion of the second member 200.

FIG. 3(C) illustrates a state subsequent to the state shown in FIG. 3(B) after the bonding roller 15 has traveled forward in direction X along the curved shape of the first member 100, and the second chuck 10 has moved further backward in direction X in order to maintain the tension of the carrier sheet 4 at the target value. As the bonding roller 15 travels, portions of the second member 200 are pressed by the bonding roller 15 and sequentially bonded to the first member 100.

The bonding roller 15 continues to travel further forward in direction X, and once the bonding roller 15 reaches a point directly above the end of the second member 200 on the second chuck 10 side, the bonding operation ends.

### Second Embodiment

FIG. 4 illustrates a bonding apparatus 1B according to a second embodiment of the present invention. The bonding apparatus 1B is an apparatus for bonding the second member 200 to the first member 100 in the atmosphere. In the present embodiment, the first member 100 is a cover glass having a thickness of from 0.3 mm to 1.1 mm, and the second member 200 is a flexible organic EL panel having a thickness of from 10 μm to 1000 μm.

As shown in the figure, in the present embodiment, the first member 100 has a flat portion and a curved portion; when viewed in direction Z, the fiat portion is rectangular, and the curved portion is bent inward. The first member 100 is a rectangular glass plate bent near a first end as the curved portion. Moreover, the second member 200 has a bonding surface 200a with an unillustrated adhesive or adhesion layer formed thereon. By the adhesive or adhesion layer of the bonding surface 200a, the second member 200 is bonded to an inside surface 100a of the first member 100, which is curved in part.

The bonding apparatus 1B according to the present embodiment differs from the bonding apparatus 1A according to the first embodiment in the following points.

In the present embodiment, the bonding stage 2 has a plurality of suction nozzles 3 provided in a horizontal mounting surface of the main body 2a. Each suction nozzle 3 is connected to a pump 19 (see FIG. 5). Once the pump 19 is activated under control of a control portion 20B, the flat portion of the first member 100 is suctioned and held firmly onto the mounting surface of the main body 2a.

In the present embodiment, the second chuck 10 is fixed to a slider 11. The slider 11 is slidably attached to a guide 12 provided on one side of a guide body 13. Moreover, the guide body 13 is fixed to the base via the second cylinder 14.

As the slider 11 under control of the control portion 20B moves forward or backward in direction Z along the guide 12, the second chuck 10, which supports the second end 4c of the carrier sheet 4, moves up or down as well. That is, the slider 11, the guide 12, and the guide body 13 correspond to a “second-chuck raising/lowering mechanism” of the present invention for moving the second chuck 10 up or down. The second cylinder 14 is controlled in the same manner as in the first embodiment.

FIG. 5 provides a control block diagram of the bonding apparatus 1B according to the present embodiment. As shown in the figure, in addition to (1) control related to adjustments of the tension of the carrier sheet 4, and (2) control related to the raising and lowering and the travelling of the bonding roller 15, the control portion 20B performs (3) control related to the raising and lowering of the second chuck 10, and (4) control related to the suctioning and holding of the first member 100 on the bonding stage 2.

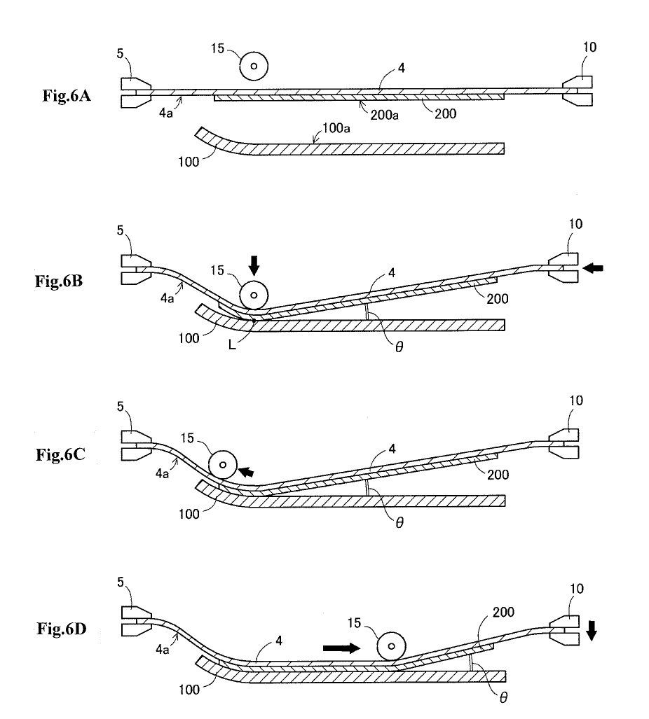

Next, the bonding operation by the bonding apparatus 1B according to the second embodiment will be described step by step with reference to FIG. 6. It should be noted that some components are omitted in FIG. 6 as well.

FIG. 6(A) illustrates an initial state prior to the start of the bonding operation. As shown in the figure, in the initial state, the second member 200 is held on the holding surface 4a of the carrier sheet 4, which is kept horizontally by the first chuck 5 and the second chuck 10, and the bonding surface 200a of the second member 200 faces the inside surface 100a of the first member 100. Moreover, the bonding roller 15 is on standby directly above the boundary between the flat portion and the curved portion of the first member 100.

FIG. 6(B) illustrates a state subsequent to the initial state shown in FIG. 6(A) after the bonding roller 15 has moved down, and the second chuck 10 has moved backward in direction X in order to maintain the tension of the carrier sheet 4 at a target value. As the bonding roller 15 moves down, the carrier sheet 4 is directly pressed by the bonding roller 15 and therefore depressed into a V-like shape, so that a portion of the second member 200 is bonded to the aforementioned boundary on the first member 100.

FIG. 6(C) illustrates a state subsequent to the state shown in FIG. 6(B) after the bonding roller 15 has traveled backward in direction X along the curved shape of the first member 100. By the traveling of the bonding roller 15, the bonding of the second member 200 to the curved portion of the first member 100 is completed. Note that the tension of the carrier sheet 4 barely changes when the bonding roller 15 travels backward in direction X, and therefore, there is no need to move the second chuck 10.

FIG. 6(D) illustrates a state subsequent to the state shown in FIG. 6(C) after the bonding roller 15 has traveled forward in direction X along the shape of the first member 100, and the second chuck 10 has moved down in order to maintain an angle between the inside surface 100a of the first member 100 and the bonding surface 200a of the second member 200 (referred to below as a “bonding angle θ”) at a target value. As the bonding roller 15 travels, portions of the second member 200 are pressed by the bonding roller 15 and sequentially bonded to the first member 100. During this, if the tension of the carrier sheet 4 increases or decreases, the second chuck 10 is simply moved backward or forward in direction X.

The bonding roller 15 continues to travel forward in direction X, and once the bonding roller 15 reaches a point directly above the end of the second member 200 on the second chuck 10 side, the bonding operation ends.

While the embodiments of the bonding apparatus according to the present invention have been described above, the present invention is not limited to the configurations of the embodiments, and various modifications can be conceived.

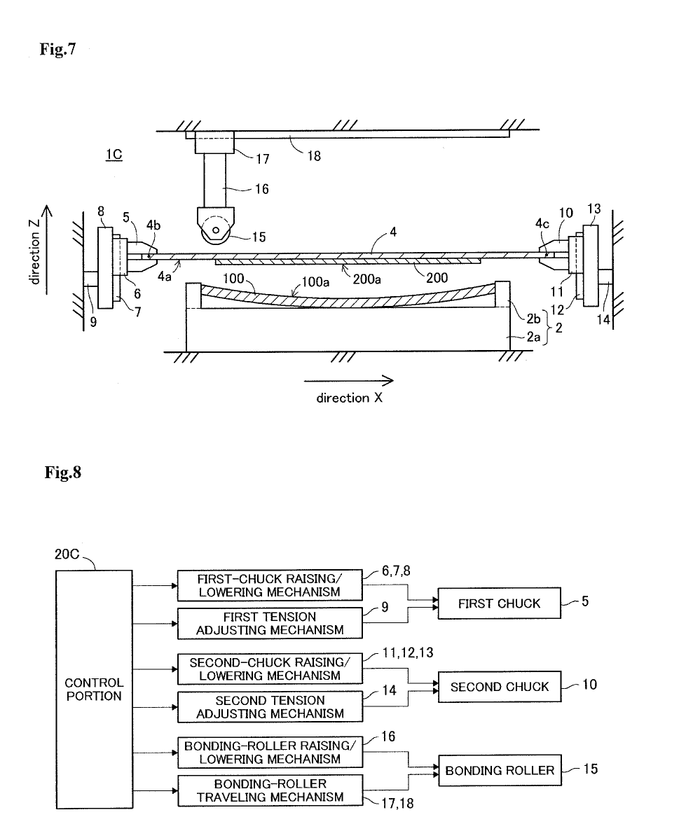

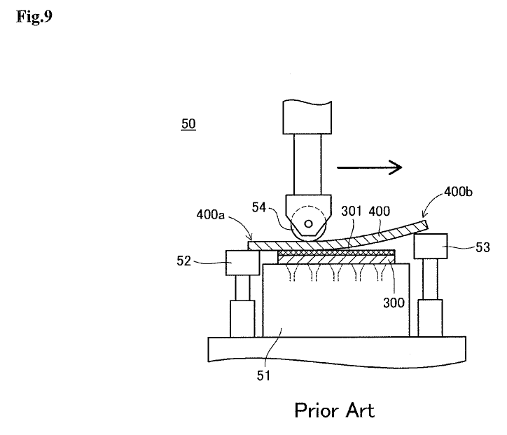

For example, as in a bonding apparatus 1C shown in FIG. 7, the first chuck 5, which corresponds to the “first support” of the present invention, may include a slider 6, a guide 7, and a guide body 8, which serve as a “first-chuck raising/lowering mechanism”, and a first cylinder 9, which serves as a “first tension adjusting mechanism”. The first-chuck raising/lowering mechanism has a configuration equivalent to the configuration of the second-chuck raising/lowering mechanism in the second embodiment. The first tension adjusting mechanism has a configuration equivalent to the configuration of the second tension adjusting mechanism in the first and second embodiments. The first-chuck raising/lowering mechanism and the first tension adjusting mechanism are controlled by a control portion 20C, as shown in FIG. 8. By achieving the configuration of the bonding apparatus 1C, it is rendered easy to deal with a variety of types of first members 100 having different curved shapes.

The “pressing portion” of the present invention may be any other member than the bonding roller 15, so long as that member is able to smoothly travel forward and backward in direction X while pressing the carrier sheet 4.

The “second holding portion” of the present invention may be any flexible sheet- or film-like member having a suction or adhesion layer for holding the second member.

It is possible to suitably change the mechanism for causing the bonding roller 15, which serves as the “pressing portion” of the present invention, to move forward and backward both in direction X and in direction Z, and also the mechanism for causing the first chuck 5 and the second chuck 10, which respectively serve as the “first support” and the “second support” of the present invention, to move forward and backward both in direction X and in direction Z.

The curved shape of the first member 100 is not limited to those described in the first and second embodiments, and may be, for example, a shape including a plurality of curves that have different bend radiuses.

The second member 200 is not limited to those described in the first and second embodiments, and may be a touch panel, for example.

### DESCRIPTION OF THE REFERENCE CHARACTERS

1A, 1B, 1C bonding apparatus

2 bonding stage

3 suction nozzle

4 carrier sheet

5 first chuck

6 slider

7 guide

8 guide body

9 first cylinder

10 second chuck

11 slider

12 guide

13 guide body

14 second cylinder

15 bonding roller

16 cylinder

17 slider

18 guide

19 pump

20A, 20B, 20C control portion

100 first member

200 second member

1-8. (canceled)

9. A method of bonding a bonding surface of a flexible second member to an inside surface of a first member being at least partially curved inward, the method comprising:
a first step of providing a bonding apparatus with a first holder, a flexible second holder, a movable presser, a first support, a second support and a tension adjusting mechanism, the presser being disposed above the second holder, the first support being configured to support a first end of the second holder, the second support being configured to support a second end of the second holder, the first end and the second end being spaced apart at a distance in a direction in which the presser moves along the curved shape of the first member, the tension adjusting mechanism being configured to set a tension of the second holder at a predetermined target value, and the tension adjusting mechanism being included in at least one of the first support and the second support;
a second step of holding the first member with the inside surface facing up on the first holder;
a third step of holding the second member with the bonding surface facing the inside surface of the first member on an area between the first end and the second end of the second holder;
a fourth step of lowering the presser so that the second holder is directly pressed by the presser and depressed into a V-like shape, whereby a portion of the second member that has been pressed indirectly from above the second holder by the presser is bonded to the first member preceding the remaining portion of the second member; and
a fifth step of moving the presser along the curved shape of the first member so that the remaining portion of the second member is bonded to the first member,
the tension adjusting mechanism narrowing the distance between the first support and the second support when the tension of the second holder exceeds the target value during the fourth step and the fifth step.

10. The method according to claim 9, and configuring the presser as a bonding roller having a radius smaller than a radius of curvature of the first member.

11. The method according to claim 9, and configuring the second holder as a sheet- or film-like member with a suction or adhesion layer formed at least in the area where the second member is held.

12. The method according to claim 9, and configuring the first member as a cover glass to which the second member is bonded, and configuring the second member as one of a flexible organic electroluminescent panel, a touch panel, and a flexible organic electroluminescent panel with a touch panel.
